(19) United States
(12) Patent Application Publication
(10) Pub. No.: US 2012/0041840 A1
(43) Pub. Date: Feb. 16, 2012

(54) HOT BUTTON FOR PERFORMANCE DIAGNOSTIC AND RECOMMENDATION

(75) Inventors: Nikolaos Georgis, San Diego, CA (US); Fredrik Carpio, San Diego, CA (US); Paul Hwang, San Diego, CA (US)

(73) Assignee: SONY CORPORATION

(21) Appl. No.: 12/853,593

(22) Filed: Aug. 10, 2010

(51) Int. Cl. G06F 11/26; G06F 3/048; G06Q 30/00; G06F 9/00

(52) U.S. Cl. 705/26.7; 714/32; 713/2; 715/809; 714/E11.159; 715/810

(57) ABSTRACT

A hot button can be pressed to cause a computer to execute a series of diagnostic tests to identify the cause of poor computer performance. When a cause is determined a website address can be presented that a user can access to purchase goods or services to alleviate the cause, and billing information may be generated in response to presentation of the website.

### I. FIELD OF THE INVENTION

The present application relates generally to using a hot button on a computer to instigate performance diagnostics and render recommendations based thereon.

### II. BACKGROUND OF THE INVENTION

Performance issues can be experienced by computer users but in many cases there is immediate feedback to the user as to the nature of the cause of poor performance. Instead, an internal monitor may periodically check for a specific performance parameter but until that occurs, the user may experience poor performance without knowing why. Furthermore, even if a monitor eventually is invoked to identify a problem, the user often is left with no more meaningful outcome or information than simply that the specific problem exists. No suggestions or remedial steps are suggested or presented to the user.

### SUMMARY OF THE INVENTION

Accordingly, a computer includes a housing, a display on the housing, and a processor in the housing controlling the display. A disk drive is in the housing in communication with the processor. Likewise, solid state memory is in the housing in communication with the processor. Also, a keypad is engaged with the housing and it communicates signals to the processor. The processor executes logic including receiving a signal from a hot button on the keypad. The hot button is a designated diagnostic button. Responsive to the signal from the hot button, the logic includes presenting on the display a verification user interface (UI) warning that continuing with a diagnostic procedure associated with the hot button may result in a restart with attendant lost data and allowing a user to continue or abort. Rresponsive to a signal indicating the user desires to continue, the processor determines whether a reboot is necessary prior to undertaking diagnostic logic and responsive to a determination that a reboot is necessary, the computer is rebooted. Responsive to a determination that reboot is not necessary, the processor executes diagnostic tests.

The tests include determining whether sufficient memory exists, and responsive to a determination that sufficient memory does not exist, a message is presented on the display to that effect. Also, the processor presents on the display recommended solutions, including presentation of a network address at which additional memory or services may be purchased. The processor generates information indicating that the address at which additional memory or services may be purchased was presented and uploads the information to a server to enable generation of billing information to bill an entity affiliated with the address at which additional memory or serve ices may be purchased.

The tests also include determining whether sufficient disk space exists, and responsive to a determination that sufficient disk space does not exist, the processor presents a message on the display to that effect and also presents on the display recommended solutions, including presentation of a network address at which additional disks or computers or services may be purchased, the processor generating information indicating that the address at which additional disks or computers or services may be purchased was presented. The processor uploads the information to a server to enable generation of billing information to bill an entity affiliated with the address at which additional disks or computers or services may be purchased.

Furthermore, the tests include determining whether usage of the processor exceeds a threshold, and responsive to a determination that usage of the processor exceeds the threshold, a message is presented on the display to that effect. Also presented on the display are recommended solutions, including presentation of a network address at which computers or services may be purchased. Information is generated indicating that the address at which computers or services may be purchased was presented, with the processor uploading the information to a server to enable generation of billing information to bill an entity affiliated with the address at which computers or services may be purchased.

If desired, memory may be tested first, followed by disk space testing, followed by processor usage testing. Or, memory may be tested first, followed by processor usage testing, followed by disk space testing.

In some implementations a button or a combination of two or more buttons on the keypad are designated by a user as the hot button. A hot button select UI can be presented on the display to this end. The hot button select UI prompts the user to select a hot, button for use in instigating diagnostic tests.

In another aspect, a computer includes a housing, a display on the housing, and a processor in the housing controlling the display. A disk drive is in the housing in communication with the processor. Likewise, solid state memory is in the housing in communication with the processor. Also, a keypad is engaged with the housing and it communicates signals to the processor. The processor executes logic including

receiving a signal from a hot button on the keypad, with the hot button being a designated diagnostic button. Responsive to the signal from the hot button, the processor executes at least one diagnostic test selected from the group of tests including determining whether sufficient memory exists, determining whether sufficient disk space exists, and determining whether usage of the processor exceeds a threshold.

Responsive to a determination that sufficient memory does not exist, the processor presents a message on the display to that effect and also presents on the display recommended solutions. On the other hand, responsive to a determination that sufficient disk space does not exist, the processor presents a message on the display to that effect and also presents on the display recommended solutions. Yet again, responsive to a determination that usage of the processor exceeds the threshold, the processor presents a message on the display to that effect and also presents on the display recommended solutions.

In another aspect, a method includes receiving a signal from a hot button on a computer and responsive to the signal, executing a series of diagnostic tests to identify a cause of poor computer performance. Responsive to determining a cause of poor computer performance, a website address is presented on the computer that a user can access to purchase goods or services to alleviate the cause, and billing information is generated responsive to presentation of the website address.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a flow chart of example logic for enabling a user to select a diagnostic hot button;

FIG. 3 is a screen shot of an example hot button selection user interface (UI);

FIG. 4 is a flow chart of example logic for diagnosing computer performance issues; and

FIG. 5 is a screen shot of an example diagnostic verification UI.

### DETAILED DESCRIPTION OF THE PREFERRED EMBODIMENT

Referring initially to FIG. 1, a system includes a computer 12 such as a laptop or notebook computer, a PC, or a personal digital assistant that in turn typically has portable lightweight plastic housing 14 bearing a digital processor 16. The processor 16 can control a visual display 18 and an audible display 20 such as one or more speakers.

To undertake present principles, the processor 16 may access one or more computer readable storage media such as but not limited to disk-based storage 22 (e.g., a hard disk drive) or solid state storage 24 (e.g., flash memory and/or dynamic random access memory (DRAM)). Typically, the solid state storage 24 is referred to simply as “memory”. In example non-limiting embodiments, the media may store various software modules, including, for example, a module bearing logic executable by the processor to undertake present principles.

The processor 16 can receive user input signals from various input devices, including a point and click device 26 such as a mouse and a keypad 28. A hot button 30 is designated on the keypad for purposes to be shortly disclosed.

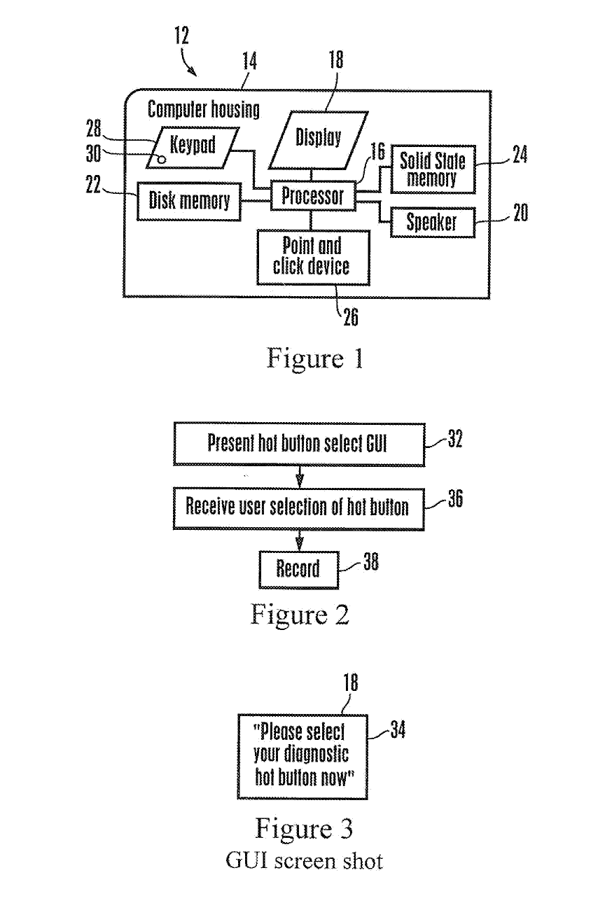

Turning to FIG. 2, the manufacturer of the computer 12 may designate one of the buttons (equivalently, a combination of two or more buttons) on the keypad 28 to be the hot button 30. Additionally, the user may be given the option of selecting his own hot button from among the keys on the keypad 28 as follows. At block 32 a hot button select UI such as the example UI 34 shown in FIG. 3 is presented on the display 18. The UI 34 may be presented as part of initial out-of-the-box power on.

As indicated in FIG. 3, the UI may prompt the user to select a hot button for use in instigating the below-described diagnostic procedure. The user's selection is received at block 36 and recorded at block 38.

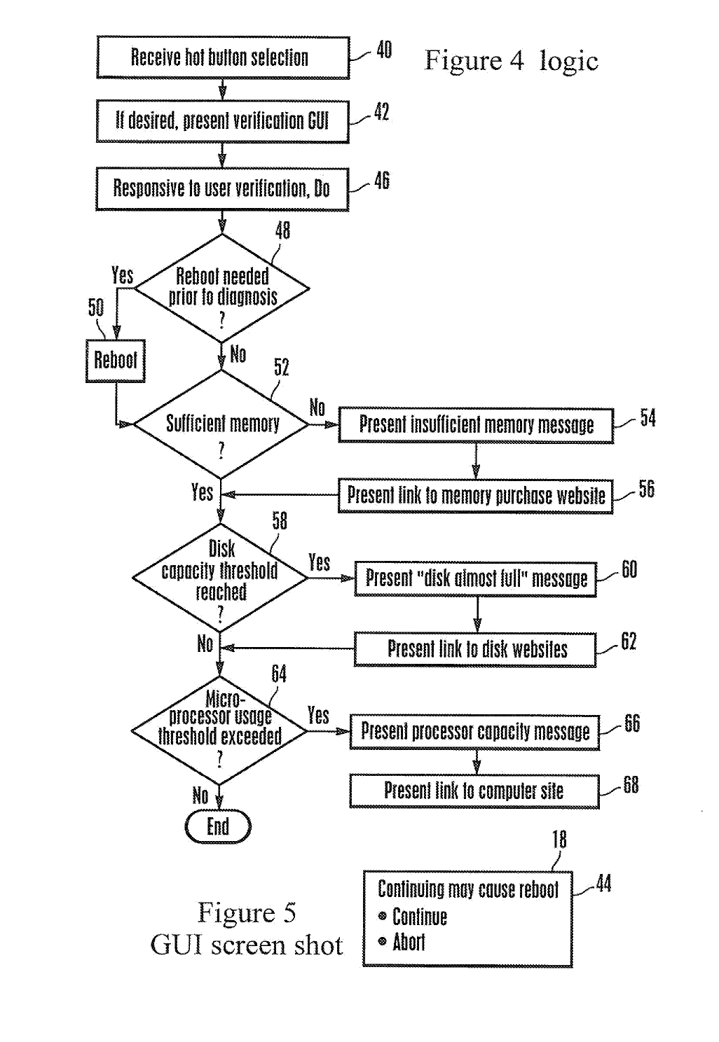

Subsequently, should the user experience poor computer performance, e.g., slow response, he may manipulate the hot button 30 and a signal is received therefrom at block 40 in FIG. 4 to cause the processor 16 to execute the following logic. If desired, at block 42 a verification UI such as the example verification UI 44 shown in FIG. 5 may be presented, warning the user that continuing with the diagnostic procedure may result in a restart with attendant lost data and asking the user if he wishes to continue or abort the logic. If the user selects “abort” the logic ends but if the user selects to continue, the logic moves to block 46 of FIG. 4 to enter the following loop.

At decision diamond 48, it is determined whether a reboot is necessary prior to undertaking the following diagnostic logic. For example, a reboot might be indicated if the computer is “hanging up” for longer than a predetermined period, e.g., several seconds. If a reboot is indicated it is executed at block 50.

After the reboot at block 50 or from decision diamond 48 if no reboot was necessary, the logic flows to a series of diagnostic tests. In the example shown, the tests need not be performed in the order illustrated, and once a test indicates a problem no additional tests of other components are undertaken. Or, in the example the tests are performed in the order shown, it being understood that the most common candidate culprit for the poor performance is tested before the other candidates. In an alternate embodiment the memory test precedes the processor test which precedes the disk test. Further, all the tests may be performed even after one test indicates a problem with one component, so as to ensure that all candidate culprits are tested in the case that more than one component may be contributing to the poor performance.

With the above in mind, at decision diamond 52 it is determined whether sufficient memory exists by, e.g., performing a memory test to determine if the memory currently is filled with data over a threshold, for instance, 90% of memory capacity. If insufficient memory exists the logic flows to block 54 to present a message on the display 18 to that effect and thence to block 56 to present recommended solutions. For example, at block 56 the processor 16 may present on the display 18 a recommendation to add memory, or to conduct memory defragmentation (unlike disk defragmentation, this is usually accomplished by a reboot). Also, as part of the corrective actions an Internet address of a website at which additional memory modules may be purchased can be presented on the display 18. When this is effected, the processor 16 may generate information indicating that the address was presented and this information is then uploaded to a server, which can generate billing information and send the bill for the website address presentation to an entity affiliated with the memory website.

From decision diamond 52 if it is determined that sufficient memory exists or from block 56, the logic flows to decision diamond 58 to determine whether a disk capacity threshold has been reached, e.g., whether the data stored on the disk 22 exceeds a predetermined threshold of the total capacity of the disk drive. If insufficient disk space exists the logic flows to block 60 to present a message on the display 18 to that effect and thence to block 62 to present recommended solutions. For example, at block 62 the processor 16 may present on the display 18 a recommendation to conduct disk defragmentation. Also, as part of the corrective actions an Internet address of a website at which disk drives or new computers may be purchased can be presented on the display 18. When this is effected, the processor 16 may generate information indicating that the address was presented and this information is then uploaded to a server, which can generate billing information and send the bill for the website address presentation to an entity affiliated with the website.

From decision diamond 58 if it is determined that sufficient disk space exists or from block 62, the logic flows to decision diamond 64 to determine whether a processor 16 usage threshold has been reached, e.g., whether the processor is busy greater than predetermined threshold percentage of the time. If processor usage exceeds the threshold the logic flows to block 66 to present a message on the display 18 to that effect and thence to block 68 to present recommended solutions. For example, at block 68 the processor 16 may present the display 18 a recommendation to visit an Internet address of a website at which upgraded processors or new computers may be purchased. When this is effected, the processor 16 may generate information indicating that the address was presented and this information is then uploaded to a server, which can generate billing information and send the bill for the website address presentation to an entity affiliated with the website. After the tests above have been completed the logic ends at state 70.

While the particular HOT BUTTON FOR PERFORMANCE DIAGNOSTIC AND RECOMMENDATION is herein shown and described in detail, it is to be understood that the subject matter which is encompassed by the present invention is limited only by the claims.

What is claimed is:

1. Computer comprising:
housing;
display on the housing;
processor in the housing controlling the display;
disk drive in the housing and communicating with the processor;
solid state memory in the housing and communicating with the processor;
keypad engaged with the housing and communicating with the processor;
the processor executing logic including:
receiving a signal from a hot button on the keypad, the hot button being a designated diagnostic button;
responsive to the signal from the hot button, presenting on the display a verification use interface (UI) warning that continuing with a diagnostic procedure associated with the hot button may result in a restart with attendant lost data and allowing a user to continue or abort;
responsive to a signal indicating the user desires to continue, determining whether a reboot is necessary prior to undertaking diagnostic logic;
responsive to a determination that a reboot is necessary', rebooting the computer;
responsive to a determination that a reboot is not necessary, executing diagnostic tests including:
determining whether sufficient memory exists, and responsive to a determination that sufficient memory does not exist, presenting a message on the display to that effect and presenting on the display recommended solutions, including presentation of a network address at which additional memory or services may be purchased, the processor generating, information indicating that the address at which additional memory or services may be purchased as presented, the processor uploading the information to a server to enable generation of billing information to bill an entity affiliated with the address at which additional memory or services may be purchased;
determining whether sufficient disk space exists, and responsive to a determination that sufficient disk space does not exist, presenting a message on the display to that effect and presenting on the display recommended solutions, including presentation of a network address at which additional disks or computers or services may be purchased, the processor generating information indicating that the address at which additional disks or computers or services may be purchased was presented, the processor uploading the information to a server to enable generation of billing information to bill an entity affiliated with the address at which additional disks or computers or services may be purchased; and
determining whether usage of the processor exceeds a threshold, and responsive to a determination that usage of the processor exceeds the threshold, presenting a message on the display to, that effect and presenting on the display recommended solutions, including presentation of a network address at which computers or services may be purchased, the processor generating information indicating that the address at which computers or services may be purchased was presented, the processor uploading the information to a server to enable generation of billing information to bill an entity affiliated with the address at which computers or services may be purchased.

2. The computer of claim 1, wherein memory is tested first, followed by disk space testing, followed by processor usage testing.

3. The computer of claim 1, wherein memory is tested first, followed by processor usage testing, followed by disk space testing.

4. The computer of claim 1, wherein a button or a combination of two or more buttons on the keypad, is designated by a user as the hot button.

5. The computer of claim 4, wherein a hot button select UI is presented on the display, the hot button select UI prompting the user to select a hot button for use in instigating diagnostic tests.

6. Computer comprising:
housing;
display on the housing;
processor in the housing controlling the display;
disk drive in the housing and communicating with the processor;
solid state memory in the housing and communicating with the processor;
keypad engaged with the housing and communicating with the processor;
the processor executing logic including:
receiving a signal from a hot button on the keypad, the hot button being a designated diagnostic button;
responsive to the signal from the hot button, executing at least one diagnostic test selected from the group of tests including;
determining whether sufficient memory exists, and responsive to a determination that sufficient memory does not exist, presenting a message on the display to that effect and presenting tin the display recommended solutions;
determining whether sufficient disk space exists, and responsive to a determination that sufficient disk space does not exist, presenting a message on the display to that effect and presenting on the display recommended solutions; and
determining whether usage of the processor exceeds a threshold, and responsive to a determination that usage of the processor exceeds the threshold, presenting a message on the display to that effect and presenting on the display recommended solutions.

7. The computer of claim 6, wherein memory is tested first, followed by disk space testing, followed by processor usage testing.

8. The computer of claim 6, wherein memory is tested first, followed by processor usage testing, followed by disk space testing.

9. The computer of claim 6, wherein responsive to a test indicating a problem with a component, no further components are tested regardless of whether other components eligible to be tested remain untested.

10. The computer of claim 6, wherein a button or a combination of two or more buttons on the keypad is designated by a user as the hot button.

11. The computer of claim 10, wherein a hot button select UI is presented on the display, the hot button select UI prompting the user to select a hot button for use in instigating diagnostic tests.

12. The computer of claim 6, wherein responsive to the signal from the hot button, the processor presents on the display a verification user interface (UI) warning that continuing with a diagnostic procedure associated with the hot button may result in a restart with attendant lost data and allowing a user to continue or abort, and
responsive to a signal indicating the user desires to continue, the processor determines whether a reboot is necessary prior to undertaking diagnostic logic and responsive to a determination that a reboot is necessary, the processor reboots the computer prior to undertaking diagnostic logic.

13. The computer of claim 6, wherein responsive to a determination that sufficient memory does not exist, the processor presents on the display recommended solutions, including presentation of a network address at which additional memory or services may be purchased, the processor generating information indicating that the address at which additional memory or services may be purchased was presented, the processor uploading the information to a server to enable generation of billing information to bill an entity affiliated with the address at which additional memory or services may be purchased.

14. The computer of claim 6, wherein responsive to a determination that sufficient disk space does not exist, the processor presents on the display recommended solutions, including presentation of a network address at which additional disks or computers sir services may be purchased, the processor generating information indicating that the address at which additional disks or computers or services may be purchased was presented, the processor uploading the information to a server to enable generation of billing information to bill an entity affiliated with the address at which additional disks or computers or services may be purchased.

15. The computer of claim 6, wherein responsive to a determination that usage of the processor exceeds the threshold, the processor presents on the display recommended solutions, including presentation of a network address at which computers or services may be purchased, the processor generating information indicating that the address at which computers or services may be purchased was presented, the processor uploading the information to a server to enable generation of billing information to bill an entity affiliated with the address at which computers or services may be purchased.

16. Method comprising:
receiving a signal from a hot button on a computer;
responsive to the signal, executing a series of diagnostic tests to identify a cause of poor computer performance;
responsive to determining a cause of poor computer performance, presenting website address on the computer that a user can access to purchase goods or services to alleviate the cause; and
generating billing information responsive to presentation of the website address.

17. The method of claim 16, wherein a first test is a solid state memory test.

18. The method of claim 17, wherein a second test is a disk capacity test.

19. The method of claim 18, wherein a third test is a processor usage test.

20. The method of claim 16, comprising
responsive to the signal from the hot button, presenting on the computer a verification user interface (UI) warning that continuing with a diagnostic procedure associated with the hot button may result in a restart with attendant lost data and allowing a user to continue or abort;
responsive to a signal indicating the user desires to continue, determining whether a reboot is necessary prior to undertaking diagnostic logic; and
responsive to a determination that a reboot is necessary, rebooting the computer.
